(19) United States
(12) Patent Application Publication
(10) Pub. No.: US 2018/0210892 A1
(43) Pub. Date: Jul. 26, 2018

(54) OBJECT OR IMAGE SEARCH WITHIN A GEOGRAPHIC REGION BY A NETWORK SYSTEM

(71) Applicant: Uber Technologies, Inc., San Francisco, CA (US)

(72) Inventors: Donald Anthony Stayner, San Francisco, CA (US); Scott Daniel Kramer, San Francisco, CA (US); Kyle Elliot DeHovitz, San Francisco, CA (US); Eric Brady Burns, San Francisco, CA (US); Ernel Murati, San Francisco, CA (US); Matthew Blake Engel, San Francisco, CA (US)

(21) Appl. No.: 15/415,782

(22) Filed: Jan. 25, 2017

(51) Int. Cl. G06F 17/30

(52) U.S. Cl. CPC G06F 17/3087; G06F 17/30253; G06F 17/30241; G06F 17/30268

(57) ABSTRACT

A network system uses the capabilities of client devices to search for objects in an image within a geographic region. The network system receives a request to search for an object and a geographic region within which to search the object. The network system provides instructions to client devices within the geographic region to search for the object. Upon receiving instructions to search for the object, the client device captures visual data of the area around the client device. The client device analyzes the visual data to detect the object and notifies the network system if the object is detected.

### BACKGROUND

### Field of Art

The present disclosure relates generally to network systems, and more specifically to searching for entities or objects within a geographic area.

### Description of Art

Typically, the attention of a driver is focused on safely and quickly reaching their destination. However, while driving, the driver may pass objects of interest to others, for example, that may be at an unknown location. Drivers typically cannot effectively be notified of the desire to locate these objects, and it would be unsafe for a driver to monitor surrounding objects to look for these objects, particularly when particular objects of interest may be uncommon.

### SUMMARY

A network system, such as a travel or transportation coordination system, can use the capabilities of networked devices, such as mobile computing devices or other client devices to search for objects, such as license plates, within a geographic region as drivers drive through the geographic region. The network system can receive a search request with information identifying a license plate or other object from a user device or another system. The information may include characteristics of the object, and as an example for a license plate, may include the license plate number, the organization or agency that issued the license plate, or the type or color of the vehicle to which the license plate is attached. The search request can also include a geographic region within which the network system is requested to search for the object.

The network system can provide search instructions to client devices of drivers within the geographic region to search for the license plate. Upon receiving instructions to search for a license plate, the client device can capture visual data of the area around the client device. The client device may capture the visual data using a camera that captures image data or video data. In embodiments where network system is a travel coordination system and the client device is a mobile phone, the client device may be mounted to the dashboard of a vehicle and the camera may be directed towards the front of the vehicle, thereby allowing the camera to capture visual data of the area in front of the vehicle.

In one example, the client device analyzes the visual data to detect surrounding license plates. In some embodiments, the client device uses object character recognition or machine-learned models to identify the license plate number of a license plate. If the client device detects the license plate in the visual data, the client device notifies the network system that the license plate is detected. The notification can include the geographic location of the client device or an estimated location of the license plate (or the vehicle associated with the license plate). The network system notifies the user or system that submitted the search request for the license plate that the license plate has been located and provides information about the location of the client device or the estimated location of the license plate.

To determine which client devices to instruct to search for a particular object, such as a license plate, the network system can determine a search zone within the geographic region. The search zone is a geographic area within which the network system instructs a set of client devices to search for the license plate. The search zone may encompass the entire geographic region specified in the search request, or may encompass only a portion of the geographic region. The network system may determine the search zone based on data stored by the network system, such as map data, traffic data, and/or the locations of client devices within the geographic region. In some embodiments, the network system dynamically adjusts the search zone while searching for the license plate. For example, the network system may expand the search zone if the object has not been detected after a threshold amount of time. Similarly, if the network system detects the object, the network system may decrease the size of the search zone to an area around the location of the detected license plate.

The network system identifies client devices within the search zone to search for the license plate. Depending on implementation, the network system may instruct all client devices within the search zone to search for the license plate or may instruct a subset of the client devices within the search zone. The network system may identify client devices for searching based on the locations of client devices within the search zone, the number of client devices within the search zone, and/or other information stored by the network system.

By using the capabilities of client devices, the network system does not require additional resources to search for an object within a geographic region. Because client devices used by drivers and/or other users are commonly already equipped with the functionality to capture visual data, the devices can search for the object as they travel around the geographic region as they otherwise would. The network system instructs the client device to capture visual data around the client device and may not require any input from the user of the client device. Additionally, by adjusting the size of the search zone or by selecting which client devices within a search zone are searching for the object, the network system can ensure that the sufficient visual data within the geographic region is captured and analyzed to detect the object without wasting resources. Thus, the network system can more effectively balance effectiveness with resource usage.

### BRIEF DESCRIPTION OF THE DRAWINGS

FIG. 1 illustrates an example system environment and architecture for a network system 120, in accordance with some embodiments.

FIG. 2 illustrates an example user interface for a user to input information about a license plate to locate, in accordance with some embodiments.

FIG. 3 illustrates an example user interface displaying the search zone to a user, in accordance with some embodiments.

FIG. 4 illustrates an example user interface displaying the location of a license plate, in accordance with some embodiments.

FIG. 5 illustrates an example user interface displaying an updated search zone after locating a license plate, in accordance with some embodiments.

FIG. 6 is a sequence diagram describing the interaction between a client device and a network system to detect a license plate within a geographic region, in accordance with some embodiments.

FIG. 7 is a block diagram illustrating components of an example machine able to read instructions from a machine-readable medium and execute them in a processor (or controller).

### DETAILED DESCRIPTION

### Example System Environment and Architecture

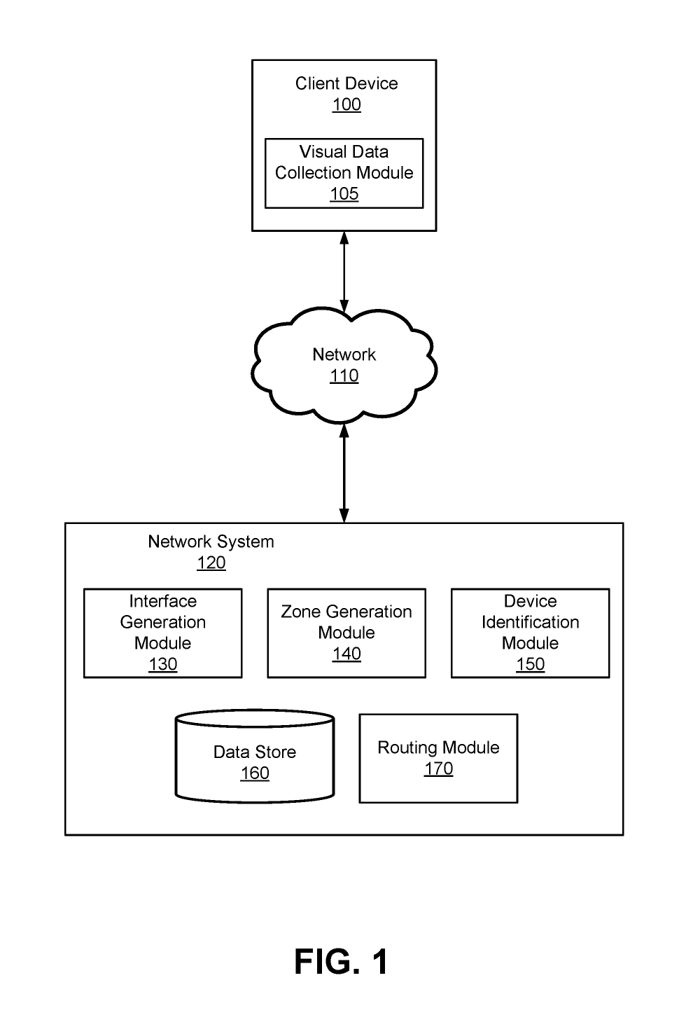

FIG. 1 illustrates an example system environment and architecture for a network system 120, in accordance with some embodiments. The illustrated system environment includes a client device 100, a network 110, and a network system 120, such as a travel or delivery coordination system. As described above, the network system 120 can receive a request from a client device 100 to detect a license plate within a geographic region. The network system 120 uses the capabilities of client devices 100 to detect the license plate.

In alternate embodiments, the functionality of each component may be distributed differently from the examples described herein, and the system environment may include more, fewer, or different components than illustrated in FIG. 1. For example, the system environment may include multiple client devices 100 in communication with the network system 120.

A user can interact with the network system 120 through a client device 100. The client device 100 can be a personal or mobile computing device, such as a smartphone, a tablet, a notebook computer, or desktop computer. In some embodiments, the personal computing device executes a client application that uses an application programming interface (API) to communicate with the network system 120 through the network 110.

In some embodiments, the network system 120 is a navigation or travel coordination system that provides navigation or travel services to users of client devices 100. Travel coordination systems provide a means of travel by connecting people who need rides (i.e., “riders”) with drivers (i.e., “providers”). A rider can submit a request for a ride to the travel coordination system and the travel coordination system selects a provider to service the request by transporting the rider to their intended destination.

In embodiments where the network system 120 is a travel coordination system, a user who is a rider can make a trip request to the network system 120 through operation of a client device 100. According to an example, a trip request can include user identification information, the number of passengers for the trip, a requested type of the provider (e.g., a vehicle type or service option identifier), the current location and/or the pickup location (e.g., a user-specific location, or a current location of the client device 100), and/or the destination for the trip. The pickup location and/or the current location of the client device 100 may be designated by the rider, or detected using a location sensor of the client device 100 (e.g., a global positioning system (GPS) receiver).

In additional embodiments where the network system 120 is a travel coordination system, a user who is a provider can use the client device 100 to interact with the network system 120 to identify riders to whom the provider can provide transportation. In some embodiments, the provider is a person operating a vehicle capable of transporting passengers or delivering goods. In some embodiments, the provider is an autonomous vehicle that receives routing instructions from the network system 120. For convenience, this disclosure generally uses a car with a driver as an example provider. However, the embodiments described herein may be adapted for a provider operating alternative vehicles.

The client device 100 can include a visual data collection module 105 that captures and/or analyzes visual data, such as image data or video data. In some embodiments, the visual data collection module 105 can be a part of, implemented by, or be in communication with a designated client application that communicates with the network system 120. The visual data collection module 105 can also communicate with a camera of the client device 100 for capturing visual data. The visual data collection module 105 receives visual data of the area around and/or in front of the vehicle. For example, if the client device 100 is a mobile phone that is positioned on the window or dashboard of a vehicle (e.g., using a phone holder), and a camera of the phone is facing outwards towards the windshield, the visual data collection module 105 may collect visual data from the area in front of the vehicle. Alternatively, the visual data collection module 105 may be coupled to a vehicle itself (e.g., cameras fixed into or on the body of the vehicle), and may communicate with the client device 100 to provide a more complete view of the area around the vehicle. The client device 100 may store visual data locally, or may send the visual data to the network system 120. In such an example, the provider client device 100 can correspond to an on-board computing system of the vehicle.

The client device 100 may capture visual data (e.g., periodically, or based on a schedule) in response to receiving search instructions from the network system 120 to search for a particular license plate. The search instructions include an identification of the license plate to be identified, such as the license plate number, the organization or agency that issued the license plate (e.g., state or local government, national agency, etc.), the type of vehicle to which the license plate is attached (including make and/or model), and/or the color of the vehicle. The search instructions may also include a time period during which the client device 100 is instructed to search and/or data about the geographic regions or boundaries within which the client device 100 is to search. The network system 120 may also provide search instructions to the client device 100 to stop searching.

The client device 100 analyzes the visual data that is captured by the visual data collection module 105 as the driver drives around a geographic region within which the network system 120 operates. If the visual data collection module 105 receives visual data of a license plate identified by search instructions, the client device 100 detects the licenses plate in the visual data. In some examples, to detect the license plate within the visual data, the client device 100 may use image processing operations, such as optical character recognition (OCR), to detect text that matches the license plate number. For example, the client device 100 may identify text within the visual data, and if the text matches the license plate number of the license plate, the client device 100 may determine that the license plate is captured by the visual data. The client device 100 also may use machine-learned computer-vision models to detect the license plate within the visual data. The machine-learned computer-vision models may detect a license plate by detecting the license plate number of the license plate, the shape of the license plate, the color of the license plate, and/or the position of the license plate on a car. In some embodiments, the client device 100 uses a machine-learned computer-vision model to identify fragments of the visual data that likely represent the license plate. The client device 100 may then use OCR to identify the license plate within the fragments of the visual data. As an addition or an alternative, the client device 100 may use information about the organization or agency, vehicle type, and/or color of the vehicle, to filter out which visual data to process (or search within for the license plate). For example, if the particular license plate to be searched is for a black sedan, the client device 100 can use machine-learned computer-vision models to ignore searching license plates for all other vehicles that are not black sedans. Such an example can reduce the amount of computational resources used by the client device 100. Still further, in some embodiments, the client device 100 transmits the visual data to the network system 120, and the network system 120 processes the visual data in order to detect the license plate in the visual data. In such an example, the client device 100 can also provide the location of the client device 100 and/or the time in which the visual data was captured along with the visual data to the network system 120.

If the client device 100 detects the license plate and/or corresponding vehicle in the visual data, the client device 100 notifies the network system 120 that the license plate has been detected. The detection notification may include the geographic location of the client device 100 and a time when the visual data was captured and/or processed (or when the license plate was detected), and/or the visual data within which the license plate is detected. In one example, the client device 100 also may estimate the location of the license plate based on the visual data and the location of the client device 100 and may transmit the estimated location to the network system 120. After detecting the license plate, according to an example, the client device 100 can monitor the license plate by continuing to capture visual data. The client device 100 also may update the network system 120 with the current location of the client device 100 or the license plate as long as the client device 100 detects the license plate in the visual data. If the client device 100 no longer detects the license plate in the visual data, the client device 100 may notify the network system 120 that the license plate is no longer detected.

In some embodiments, the client device 100 only stores captured visual data if the client device 100 detects the license plate. Otherwise, the client device 100 may only store a set amount of the visual data. Upon detection of the license plate, the client device 100 may locally cache the visual data and sends the cached visual data to the network system 120 upon request from the network system 120. The client device 100 may continue to cache visual data until the network system 120 instructs the client device 100 to stop caching the visual data. Alternatively, the client device 100 may cache visual data until the client device 100 no longer detects the license plate in the visual data.

The client device 100 can communicate with network system 120 via the network 110, which may comprise any combination of local area and wide area networks employing wired or wireless communication links. In one embodiment, the network 110 uses standard communications technologies and protocols. For example, the network 110 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any format, such as hypertext markup language (HTML) or extensible markup language (XML). In some embodiments, all or some of the communication links of the network 110 may be encrypted.

FIG. 1 illustrates an example system architecture of the network system 120, in accordance with some embodiments. The illustrated network system 120 includes an interface generation module 130, a zone generation module 140, a device notification module 150, a data store 160, and a routing module 170. Alternate embodiments may include more, fewer, or different components from those illustrated in FIG. 1, and the functionality of the components may be divided up differently from the description below.

The interface generation module 130 provides a frontend interface to the client device 100 to communicate with the network system 120 through the network 110. The interface generation module 130 may provide application programming interface (API) functionality to send data directly to native client device operating systems. The interface generation module 130 may receive and route messages between the network system 120 and the client device 100. Additionally, the interface generation module 130 can serve web pages, as well as other web-related content.

The interface generation module 130 can provide an interface to a client device 100 that allows a user to submit a search request to locate a license plate using the network system 120. The search request can include information about the license plate to locate, such as the license plate number, the agency or organization that issued the license plate (e.g., a national or state agency), the expiration date of the license plate, or the type or color of the vehicle to which the license plate is attached. A user device or system operated by the user can generate such a search request and transmit the search request to the network system 120. The search request can also include a geographic region within which the network system 120 searches for the license plate. Furthermore, the interface generation module 130 can provide a user interface to the user through a client device 100 that allows the user to specify the geographic region to search. The interface generation module 130 may allow the user to specify pre-determined boundaries (e.g., city boundaries, county boundaries, country boundaries, etc.), or may allow the user to specify a custom geographic region. In some embodiments, the user interface recommends adjustments to the geographic region to the user based on an initial geographic region provided by the user. For example, if the initial geographic region provided by the user includes a freeway, the interface generation module 130 may suggest to the user to adjust the geographic region by 2 miles in each direction of the freeway to more thoroughly cover the traffic traveling on the freeway. Additionally, if the boundary initial geographic region is next to an area that tends to have a high density of drivers, the interface generation module 130 may suggest to the user to adjust the geographic region to include the area with the high density of drivers.

The interface generation module 130 may also provide an interface to the user that specifies when and where the license plate is detected within the geographic region. The interface generation module 130 may provide an up-to-date feed with the current location of the license plate so long as a client device 100 continues to detect the license plate in its visual data. If the license plate was detected but is no longer detected in the visual data of client devices 100 in the geographic region, the interface generation module 130 may display the location of the license plate when it was last detected. Additionally, the interface generation module 130 may display a zone within which the license plate is most likely to be, based on the last known location of the license plate or map data about the geographic region.

The zone generation module 140 generates a search zone for the network system 120. The search zone is the geographic area within which the network system 120 searches for the license plate. The search zone may be the entire geographic region specified by the user submitting the search request or may be a portion of the geographic region. The zone generation module 140 can determine the search zone based on data stored in the data store 160, such as map data, traffic data, weather data, driver supply data, and trip demand data. For example, the zone generation module 140 may determine a model for the likelihood that the license plate will be in a particular portion of the geographic region based on map data or traffic data, and may generate a search zone that encompasses the portions of the geographic region where the license plate is most likely to be. In some embodiments, the zone generation module 140 adjusts the search zone over time. For example, the zone generation module 140 may expand the search zone if the license plate has not been found for a long period of time. In some embodiments, the zone generation module 140 ensures that the search zone is always contained by the geographic region specified by a user. Alternatively, the zone generation module 140 can generate a search zone that is mostly contained by the geographic region, though part of the search zone may be outside if, for example, the license plate was recently detected close to the edge of the geographic region.

When a client device 100 detects the license plate, the zone generation module 140 may adjust the search zone based on the detected location of the license plate. For example, if the license plate is detected, the zone generation module 140 may decrease the size of the search zone to a smaller area around the detected location of the search zone. In some embodiments, the zone generation module 140 adjusts the search zone based on data stored by the network system 120. For example, if the license plate is detected on a one-way street according to map data stored in the data store 160, the zone generation module 140 may adjust the search zone to encompass geographic area in the direction of the one-way street. The zone generation module 140 may also adjust the search zone based on whether a client device 100 previously but no longer detects the license plate. For example, if a client device 100 previously detected the license plate but does not detect the license plate anymore, the zone generation module 140 may expand the search zone to increase the likelihood of detecting the license plate again.

The device identification module 150 identifies client devices 100 within the search zone and instructs those client devices 100 to capture visual data to detect the license plate. In some embodiments, the device identification module 150 only identifies drivers that are online. The device identification module 150 can transmit instructions to the client devices 100 through the network 110, and those instructions can include information about the license plate to detect. The device identification module 150 can determine whether a client device 100 is within the search zone based on the geographic location of the client device. If a client device 100 is within the search zone, the device identification module 150 can instruct the client device 100 to search for the license plate by capturing and analyzing visual data to detect a license plate. The device identification module 150 may also identify when a client device 100 is no longer within the search zone and can instruct the client device 100 to stop capturing and analyzing visual data upon leaving the search zone. In some embodiments, the device identification module 150 transmits instructions to client devices 100 based on whether the license plate is detected by a client device 100. For example, the device identification module 150 may instruct some or all of the client devices 100 within the search zone to stop searching for the license plate if the license plate is located.

If the network system 120 receives more than one search request to locate different license plates, the device identification module 150 can transmit instructions to client devices 100 to search for one or more of the license plates. For example, for a particular client device 100, the device identification module 150 may identify search zones within which the client device 100 is located, and may instruct the client device 100 to search for the license plates associated with the identified search zones. Alternatively, if a client device 100 is located within a search zone, the device identification module 150 may instruct a client device 100 to search for all license plates for which the network system 120 is searching, or for license plates associated with search zones near the client device 100.

The data store 160 stores data for the network system 120. For example, the data store may store user profile data, which can include a user's name, address, whether the user is a rider or a driver, a vehicle associated with the user, or the rate at which the user uses the network system 120. The data store 160 may also store map data, which can include street names, street locations, street speed limits, street directionality, intersection locations, or intersection rules (e.g., turn restrictions). In embodiments where the network system 120 is a travel coordination system, the data store 160 may also store driver supply data and trip demand data, which, respectively, describe the supply of drivers available to provide transportation to riders and the demand from riders for trips from drivers. The data store 160 may also store information about trips taken using the network system 120, such as the start and end locations of trips, the start and end times of trips, identification information of the rider and driver associated with a trip, the distance and duration of a trip, the route taken on the trip, or the price of the trip. The data store 160 may also store data generated by the network system 120, such as models for driver supply and trip demand. The data store 160 may categorize data based on a particular geographic region, a rider, or a driver with which the data is related.

The data store 160 may store information used by the network system 120 to search for and detect license plates within a geographic region. For example, the data store 160 may store a set of license plates to search for, geographic regions associated with each license plate, search zones associated with each license plate, which client devices are searching for license plates, or a current or last-known location for a license plate. The data store 160 may also store visual data received from client devices 100 and whether a license plate has been detected within the visual data.

In some embodiments, the network system 120 includes a routing module 170 that provides routing instructions to a driver. In embodiments where the network system 120 is a travel coordination system, the routing module 170 provides routing instructions to a driver's client device 100 to travel to a rider's pickup location or destination. The routing module 180 may determine the routing instructions based on map data, traffic data, weather data, accident data, or construction data. The routing module 170 may adjust routing instructions to take a driver through a search zone for a license plate. For example, if a driver is traveling near a search zone, the routing module 170 may adjust the routing instructions so that the driver drives through the search zone. The routing module 170 may reroute a driver through a search zone based on the number of drivers that are already within the search zone. For example, if there are few drivers within the search zone, the routing module 170 may reroute a driver near the search zone to travel through the search zone. In some embodiments, the routing module 170 uses a threshold for the additional trip duration needed to reroute a driver through a search zone to determine whether to reroute the driver through the search zone. For example, if the additional time of rerouting the driver through the search zone is less than a threshold amount of time or a threshold percentage of the original trip duration, then the routing module 170 may reroute the driver through the search zone.

### Example User Interface

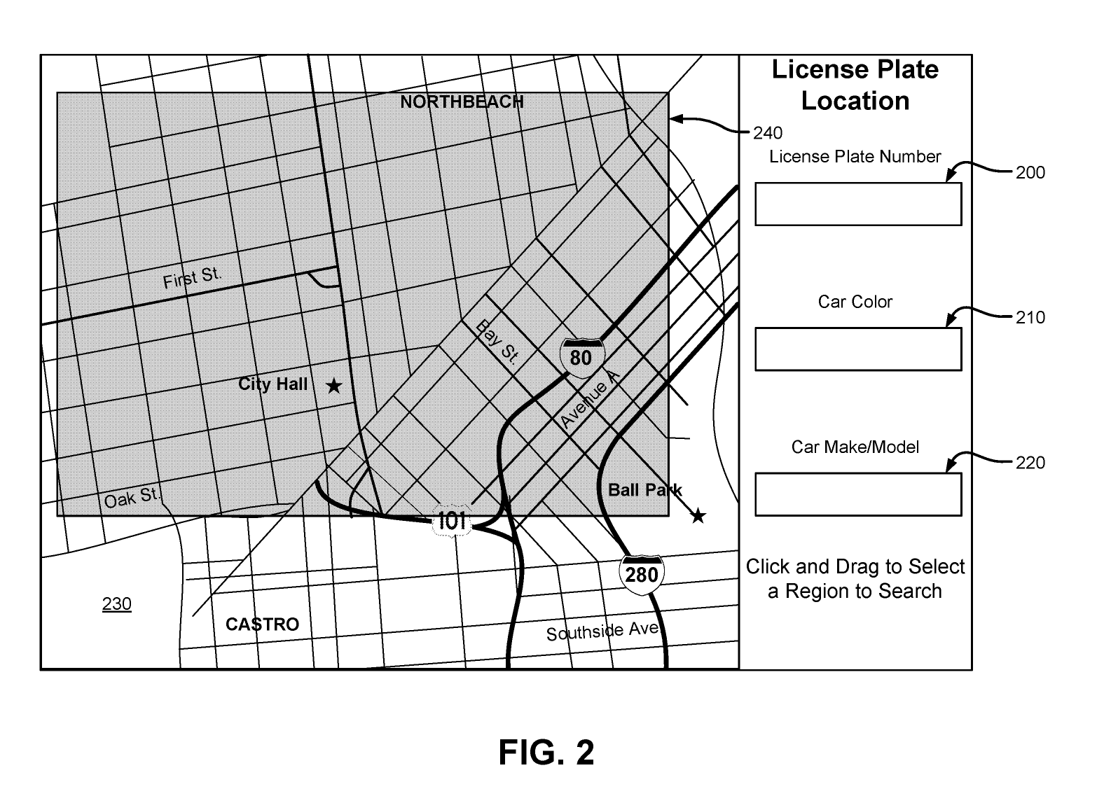

FIGS. 2 through 5 illustrate example user interfaces to be presented on a client device, in accordance with some embodiments. The illustrated user interfaces allow a user to provide information about a license plate to locate and to be provided with the location of the license plate.

FIG. 2 illustrates an example user interface for a user to input information about a license plate to locate, in accordance with some embodiments. The user may be prompted to provide the network system with the license plate number 200, the color of the vehicle to which the license plate is attached 210, and the make and model of the vehicle 220. FIG. 2 also includes a map 230 of an area within which the network system operates. The user can designate the geographic region 240 within which the network system searches for the license plate. While the embodiment illustrated in FIG. 2 illustrates a graphical map on which the user designates the geographic region, alternate embodiments may include a drop-down menu of pre-defined geographic regions (e.g., cities, counties, states, countries) or a text field to specify an geographic region (e.g., a threshold distance around an address or geographic coordinates).

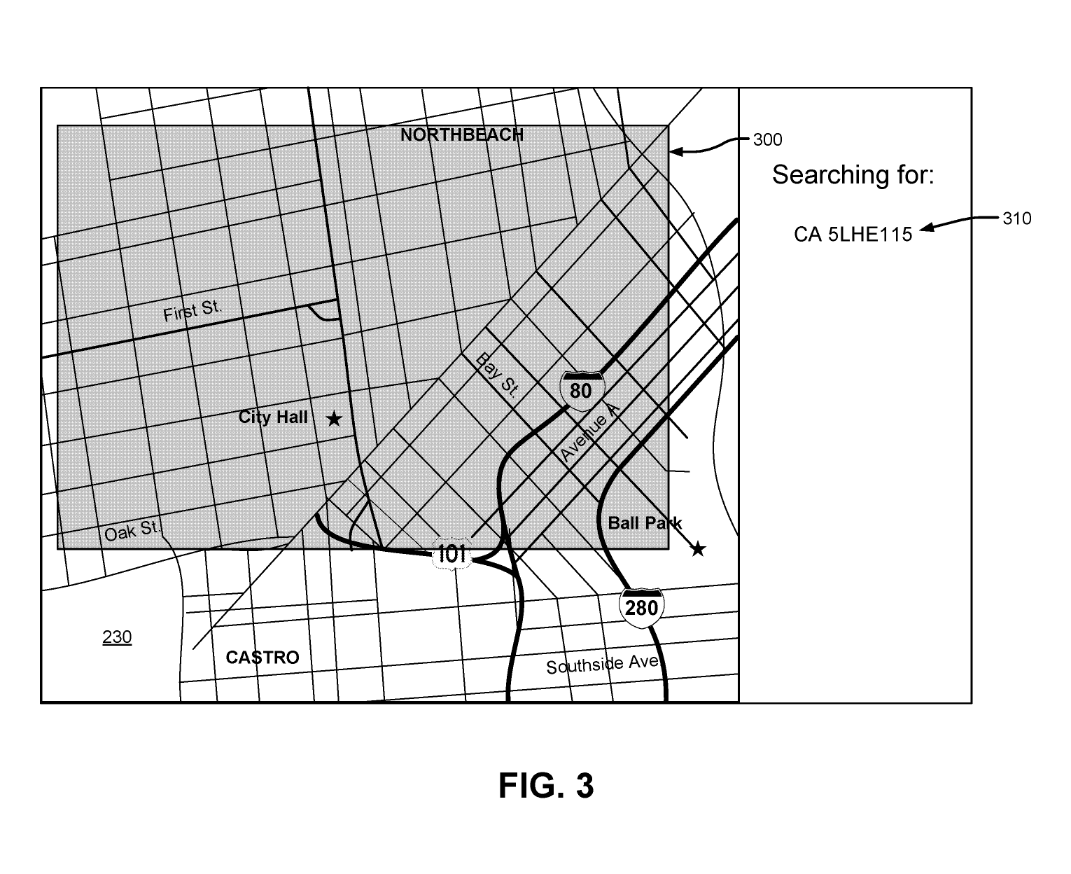

FIG. 3 illustrates an example user interface displaying the search zone 300 to a user, in accordance with some embodiments. The user interface may also display the license plate number 310 of the license plate for which the network system is searching. The search zone 300 may initially be the geographic region specified by the user. As the network system searches for the license plate, the search zone may be adjusted based on whether the license plate is detected, traffic conditions, or map data. The user interface may be adjusted based on the adjustments made to the search zone 300 during the search.

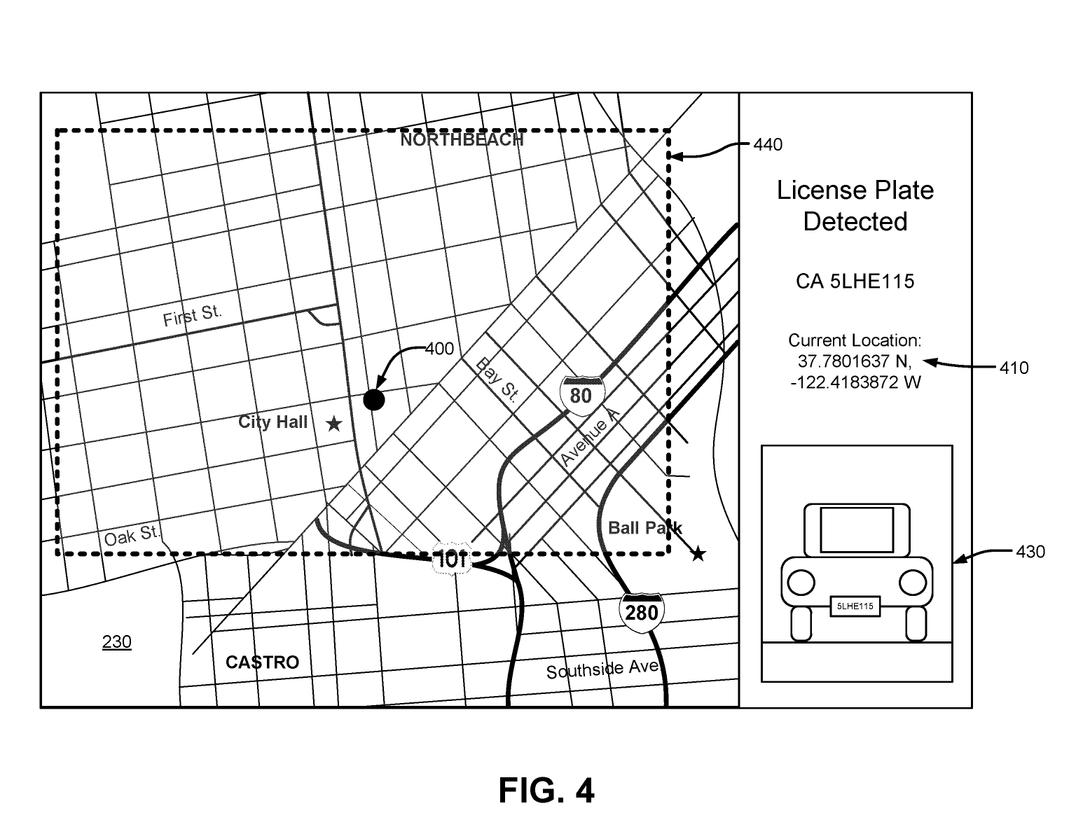

FIG. 4 illustrates an example user interface displaying the location 400 of a license plate, in accordance with some embodiments. The user interface also displays additional information about the located license plate, such as the coordinates 420 of the located license plate or visual data 430 of the license plate. The user interface can also display the geographic region 440 within which the network system searched for the license plate.

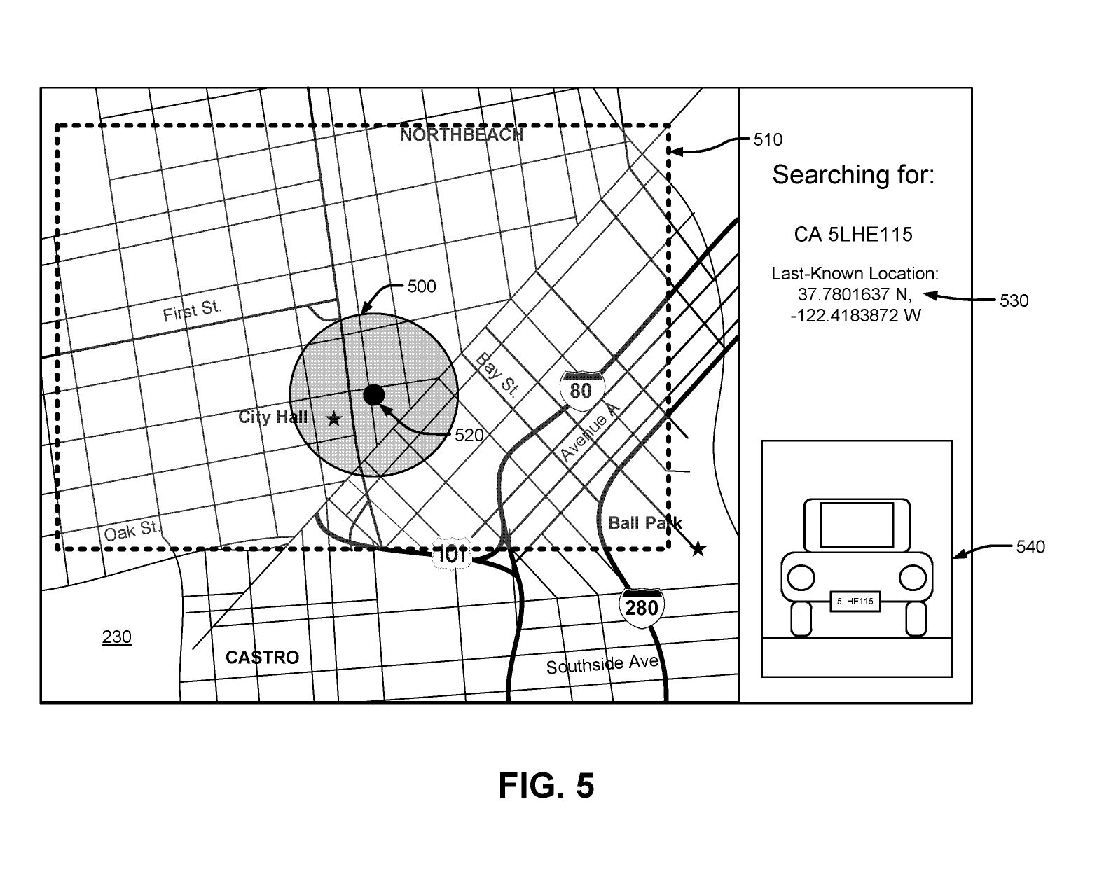

FIG. 5 illustrates an example user interface displaying an updated search zone 500 after locating a license plate, in accordance with some embodiments. The network system may have located the license plate, but the license plate may no longer be detected in visual data captured by driver devices. The updated search zone 500 may be adjusted to be a portion of the geographic region 510 specified by the user based on the last-known location of the license plate. The user interface can display the last-known location 520 on the map interface 230, as well as the last-known coordinates 530 and the visual data 540 within which the license plate was detected. Additionally, the user interface may display the geographic region 540 specified by the user.

### Detecting License Plates

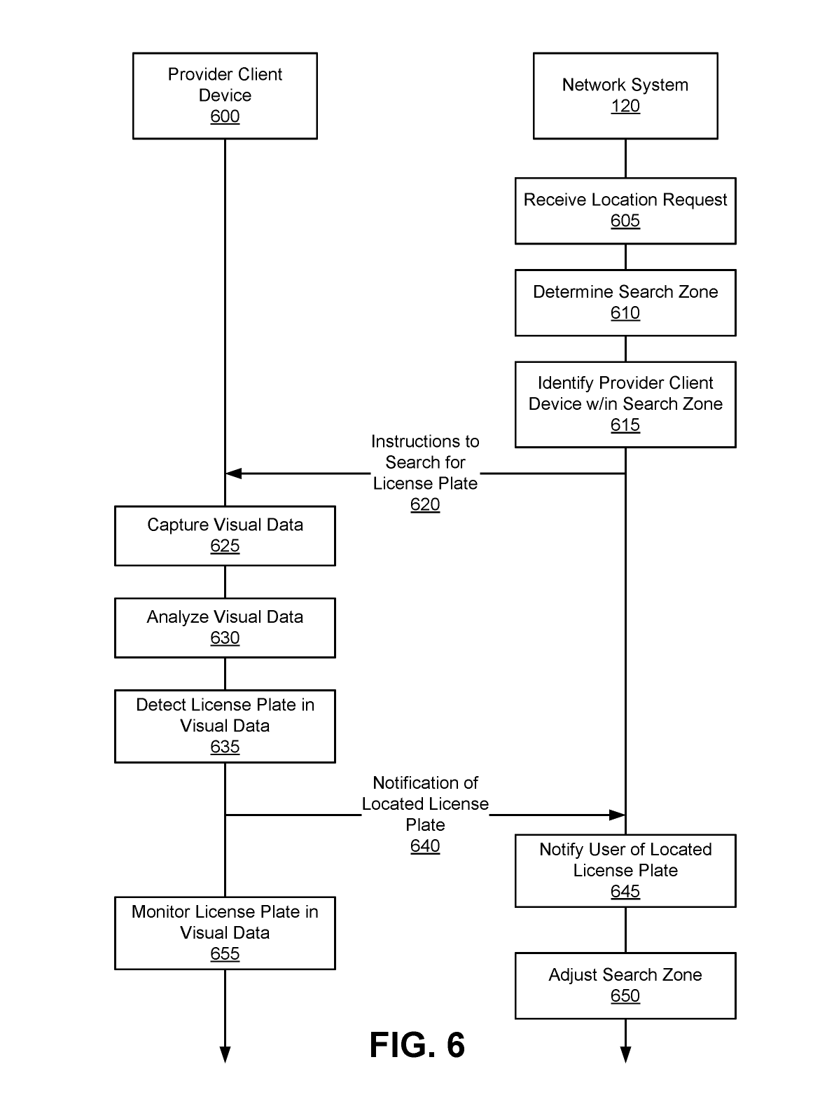

FIG. 6 is a sequence diagram describing the interaction between a client device 600 and a network system 120 to detect a license plate within a geographic region, in accordance with some embodiments. Alternate embodiments may include more, fewer, or different steps from those presented in FIG. 6, and the steps may be performed in a different order from the one described below. Additionally, the steps may be divided up between the client device 100 and the network system 120 differently from that shown in FIG. 6, and the steps may be performed by additional components than those in FIG. 6.

The network system 120 receives 605 a search request from a user's client device to locate a license plate. The search request can include information identifying the license plate and a geographic region to search within. The network system 120 determines 610 a search zone within which the network system 120 searches for the license plate. The search zone can be the entire geographic region, or can be a portion of the geographic region. In some embodiments, the network system 120 determines the search zone based on map data, traffic data, or the positions of drivers within the geographic area.

The network system 120 identifies 615 a set of client devices 100 within the search zone. The set of client devices 100 can include all client devices 100 within the search zone, or subset of the client devices 100. In some embodiments, the network system 120 identifies the set of client devices 100 based on map data, traffic data, or the positions of the client devices within the search zone.

The set of client devices 100 includes client device 600. The network system 120 transmits instructions 620 to the client device 600 to search for the license plate. The client device 600 captures 625 visual data of the area surrounding the client device 600. For example, the client device 600 may use the camera in a mobile phone mounted to the dashboard of the driver's vehicle to capture visual data of the area in front of the driver's vehicle. The client device 600 analyzes 630 the captured visual data to detect 635 the license plate. The client device 600 may analyze the visual data by using OCR or a machine-learned model for detecting license plates. In some embodiments, the client device 600 identifies text within the visual data and compares the text to the license plate number of the license plate. If the text matches the license plate number, the client device 600 detects the license plate in the visual data.

If the client device 600 detects 635 the license plate in the visual data, the client device 600 transmits a notification 640 to the network system 120 that the license plate has been located. The notification 640 can include the geographic location of the client device 600 and the visual data within which the license plate was located. The network system 120 can notify 645 the user who submitted the search request that the license plate has been located. The notification may include the location of the client device 600 or the visual data in which the license plate was detected. The network system 120 may also adjust 650 the search zone based on the location of the detected license plate. For example, the network system 120 may reduce the size of the search zone to an area around the location of the license plate so that provide client devices 100 that are not near the license plate are not needlessly capturing visual data.

The client device 600 monitors 655 the license plate in visual data being captured by the client device 600. In some embodiments, the client device 600 continually transmits the location of the license plate as long as the license plate is detected in visual data being captured by the client device 600. If the client device 600 no longer detects the license plate in the visual data, the client device 600 may send a notification to the network system 120 that the license plate is no longer detected.

### Additional Configurations

While the present disclosure is discussed predominantly in the context of license plate detection, the methods and systems herein can be adapted to detect any entity through the capture of visual data on client devices. For example, a network system can receive an entity search request from a client device. The entity search request can identify a geographic region and an entity to locate within that region. The network system can determine a search zone based on the geographic region, where the search zone can be the whole geographic region or only a portion of the geographic region. The network system can identify a plurality of client devices that correspond to a plurality of drivers within the search zone. The drivers may be online within the network system.

The network system may transmit instructions to a set of the plurality of client devices to search for the identified entity within the search zone. The network system can receive a notification from one of the client devices that the client device has detected the entity based on visual data captured by the client device. The notification may include a geographic location of the client device. The network system can transmit a notification to the client device that sent the entity search request that the entity has been located. The notification may include the geographic location of the client device that detected the entity. The network system may then adjust the search zone based on the geographic location of client device that detected the entity.

The methods and systems herein may be used to improve the network system. The client devices may be instructed to detect anomalies within a geographic region, such as construction, weather, or traffic accidents that may impact the trip durations of trips provided by the drivers. The location of the anomalies may be stored by the network system and may be used to determine routing instructions for drivers (e.g., when providing transportation to a rider).

Additionally, in embodiments where the network system is a travel coordination system, the client devices may use facial recognition to identify riders when a driver is picking up a rider. The network system may store images of each rider, and can compare the images of the riders to people around the driver's vehicle to determine where the rider is standing to be picked up. In some embodiments, the client device displays the visual data and overlays the rider's position on the displayed visual data.

In addition, the network system may locate new businesses using the methods and systems herein. The network system can store the locations of businesses within a geographic region. A client device may capture visual data of a new business within the geographic region and transmit the visual data to the network system along with the location of the client device. The network system may determine whether the business at the client device's location has changed based on the visual data and, if it has, the network system updates the business associated with that location with the new business detected by the client device.

In embodiments where the network system is a travel coordination system, the network system may also use the client devices to ensure that drivers properly identify themselves for riders. For example, drivers may be required to authenticate themselves as drivers of the network system by displaying an authenticator, such as a decal or a license, to riders. The client devices may identify a vehicle with a license plate that corresponds to a license plate for a driver of the network system, and may then identify whether the authenticator is properly displayed on the vehicle. If the authenticator is not properly displayed, the network system may alert the driver to notify them to fix the improper authenticator. Similarly, the network system may detect whether a vehicle displays an authenticator and may determine the license plate of the vehicle with the authenticator. If the license plate does not match with any of the drivers associated with the network system, the network system can determine that the vehicle is impersonating a real driver. In some embodiments, if the network system detects a license plate of a driver's vehicle, the network system may instruct the client device to detect issues with the driver's vehicle, such as broken taillights or deflated tires. Furthermore, the network system may identify the license plate of a driver associated with the network system, and detect whether the driver also displays an authenticator for a different network system on the driver's vehicle.

Additionally, the network system can detect issues with road conditions using the systems and methods herein. For example, the client devices may be configured to detect potholes, cracked curbs, broken traffic lights, faded paint lines or fallen tree branches.

### Example Machine Architecture

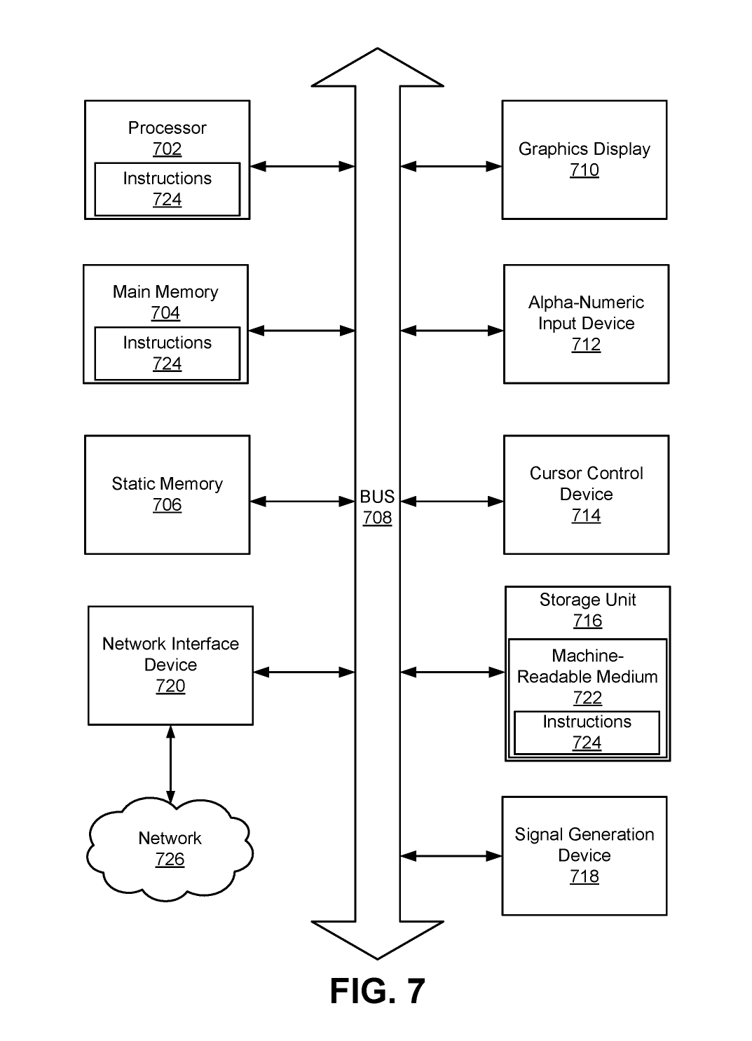

FIG. 7 is a block diagram illustrating components of an example machine able to read instructions from a machine-readable medium and execute them in a processor (or controller). Specifically, FIG. 7 shows a diagrammatic representation of a machine in the example form of a computer system 700. The computer system 700 can be used to execute instructions 724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processing units (generally processor 702). The processor 702 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 700 also includes a main memory 704. The computer system may include a storage unit 716. The processor 702, memory 704, and the storage unit 716 communicate via a bus 708.

In addition, the computer system 706 can include a static memory 706, a display driver 710 (e.g., to drive a plasma display panel (PDP), a liquid crystal display (LCD), or a projector). The computer system 700 may also include alphanumeric input device 712 (e.g., a keyboard), a cursor control device 714 (e.g., a mouse, a trackball, a joystick, a motion sensor, or other pointing instrument), a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

While the methods and systems described herein are described in the context of experiments performed on a network system, these methods and systems can be used more generally for any purpose where there is a need to present experiments to a user. For example, the experiments may be conducted by measuring any variable either manually or using an automated system, and may be presented by a system maintained by an individual, a university, an organization, a corporation, or any entity that conducts and maintains research and experiments.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at a network system, data corresponding to an entity search request from a client device, the entity search request identifying an entity to locate and a geographic region;
determining a search zone based on the geographic region, the search zone being a portion of the geographic region;
identifying a plurality of client devices corresponding to a plurality of drivers within the search zone;
transmitting instructions to a set of the plurality of client devices to search for the entity within the search zone;
receiving a notification from a client device of the set of client devices that the client device has detected the entity based on visual data captured by the client device, the notification comprising a geographic location of the client device; and
transmitting a notification to the client device that the entity has been located, the notification comprising the geographic location of the client device.

2. The method of claim 1, wherein the entity is a license plate, and the entity search request comprises a license plate number associated with the license plate.

3. The method of claim 1, wherein the entity is at least one of traffic or construction within the geographic region.

4. The method of claim 1, further comprising adjusting the search zone based on the geographic location of the client device.

5. The method of claim 1, wherein adjusting the search zone comprises decreasing a size of the search zone to an area around the location of the client device.

6. The method of claim 1, wherein the entity is an authenticator on a vehicle identifying the vehicle as a driver of the network system.

7. The method of claim 1, further comprising determining the set of the plurality of drivers based on at least one of a number of drivers in the search zone and locations of drivers within the search zone.

8. The method of claim 1, where in the search zone is determined based on a model of where the entity is likely to be within the geographic region.

9. The method of claim 1, wherein the notification from the client device that the entity has been detected comprises an estimate of a location of the entity.

10. The method of claim 1, further comprising:
receiving a notification from the client device that the entity is no longer detected in visual data captured by the client device; and
adjusting the search zone based on the notification that the entity is no longer detected by the client device.

11. The method of claim 1, further comprising:
responsive to receiving the notification that the client device detects the entity, transmitting to a driver device of the set of driver devices instructions to stop searching for the entity.

12. The method of claim 1, further comprising:
monitoring locations of client devices within the geographic region;
responsive to determining that a first client device has entered the search zone, transmitting to the first client device instructions to search for the entity; and
responsive to determining that a second client device in the set of client devices searching for the entity has left the search zone, transmitting to the second client device instructions to stop searching for the entity.

13. The method of claim 1, wherein the notification to the client device that the entity has been located comprises visual data from the client device within which the client device detected the entity.

14. The method of claim 1, further comprising:
determining a set of client devices outside of the search zone; and
transmitting routing instructions to the set of client devices outside of the search zone, the routing instructions to each client device outside of the search zone routing the client device through the search zone.

15. A method comprising:
receiving, by a client device associated with a driver, instructions from a network system to search for a license plate, the instructions comprising a license plate number associated with the license plate;
detecting the license plate by:
capturing visual data of an area around a driver, the visual data comprising at least one of video data or image data, and
identifying text within the visual data that matches the license plate number by applying object character recognition to the visual data; and
responsive to detecting the license plate:
determining a location of the client device, and
transmitting a notification to the network system that the license plate has been detected by the client device, the notification comprising the location of the client device.

16. The method of claim 15, further comprising:
determining an estimate of a location of the license plate based on the visual data and the location of the client device; and
transmitting the notification to the network system that the license plate has been detected by the client device, the notification further comprising the estimate of the location of the license plate.

17. The method of claim 15, further comprising receiving instructions from the network system to stop searching for the license plate.

18. The method of claim 15, further comprising:
capturing additional visual data of the area around the driver; and
responsive to not identifying text within the visual data that matches the license plate number associated with the license plate, transmitting a notification to the network system that the license plate is no longer detected by the client device.

19. The method of claim 15, wherein detecting the license plate further comprises applying a machine-learned model for detecting the license plate to the visual data.

20. The method of claim 15, further comprising, responsive to detecting the license plate, storing the visual data on the client device, and wherein the notification that the license plate has been detected by the client device further comprises the visual data.
